(19) United States
(12) Patent Application Publication
(10) Pub. No.: US 2016/0187947 A1
(43) Pub. Date: Jun. 30, 2016

(54) CONTROLLING THE OPERATIONAL STATE OF A CONNECTED DEVICE POWERED BY A MUTUALLY CONNECTED POWER SOURCE

(71) Applicant: WEN-HSIEN LAI, Taoyuan Hsien (TW)

(72) Inventor: WEN-HSIEN LAI, Taoyuan Hsien (TW)

(73) Assignee: IN WIN DEVELOPMENT, INC., Taoyuan Hsien (TW)

(21) Appl. No.: 14/583,741

(22) Filed: Dec. 28, 2014

(51) Int. Cl. G06F 1/26; G06F 1/28

(52) U.S. Cl. CPC G06F 1/263; G06F 1/28

(57) ABSTRACT

The present invention discloses a controlling the operational state of a connected device powered by a mutually connected power source, in which a PD (Powered Device) Module is installed in a general computer system, and via PSE (Power Source Equipment) supply power to a PD Module, via Connected Device Control the synchronous power of the PD Module to detect and control turning on and turning off the power supply.

### FIELD OF THE INVENTION

The present invention relates to controlling the operational state of a connected device powered by a mutually connected power source, and more particularly to controlling the supply of power to a connected device to make the operational state of the connected device match the operational state of the computer system.

### DESCRIPTION OF THE PRIOR ART

In general, when a connected device is powered by a shared power source the operational state of each device must be controlled individually. This requires the operator to think of the devices as being separate even though functionally they are to the operator one system.

### SUMMARY OF THE INVENTION

The primary object of the present invention is controlling the operational state of a connected device powered by a mutually connected power source, wherein control the power source and therefore operational state of the connected device to allow the computer system to make the operational state of the connected device match the computer system. The connected device (CD) and the computer system are connected to a Powered Device (PD) module that is integral to the computer system. The PD module receives power from a connected Power Source Equipment (PSE). The PD module converts the PSE power to a suitable voltage source to power a connected peripheral or system Connected Device (CD). The PD module may convert the PSE voltage source to an AC voltage source or a DC voltage source depending on the requirements of the CD. The PD module provides an uninterrupted voltage source to the computer system that contains the PD module. The invention monitors the operational state of the computer system to determine what the operational state of the CD must be to match. The invention then controls the power source to the CD to make the CD match the operational state of the computer system, which allows the CD and system to function like they have a single power control.

### BRIEF DESCRIPTION OF THE DRAWINGS

FIG. 1 shows a circuit block diagram of the present invention.

FIG. 2 shows a circuit block diagram according to a computer system of the present invention.

### DETAILED DESCRIPTION OF THE PREFERRED EMBODIMENTS

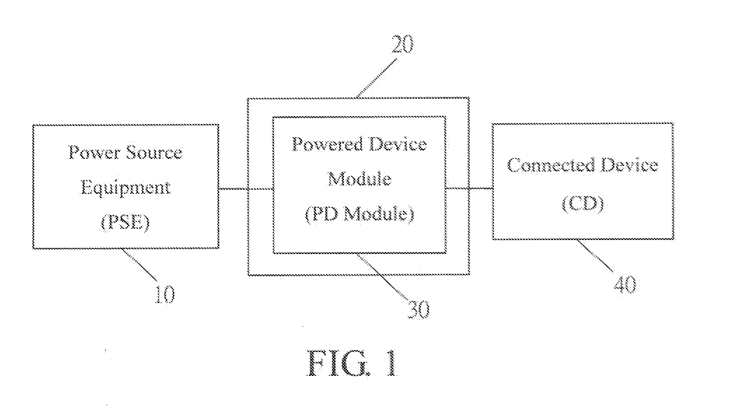

Referring to FIG. 1, a power source equipment (PSE) 10 is connected to a power device module (PD module) 30 that is integral to the computer system 20. A connected device (CD) 40 connects to the PD module 30. The PSE 10 provides a power source to the PD module 30. The PD module 30 then provides a power source to the computer system 20 and the CD 40. The power from PSE 10 is provided uninterrupted to the PD module 30, the PD module 30 then converts the power from the PSE 10 to the required power characteristics for the computer system 20 and CD 40. The power characteristics of the computer system 20 and CD 40 can be the same or different. The PD module 30 is also connected to the computer system 20 status lines. The system status lines indicate system power state by detecting the presence of a motherboard status signal or by monitoring a voltage signal that is only in one known state that matches the operational state of the computer system 20. The supply of the power source to the CD 40 is the controlled by the state if the system status lines to cause the CD 40 operational state to match the computer system 20 operational state.

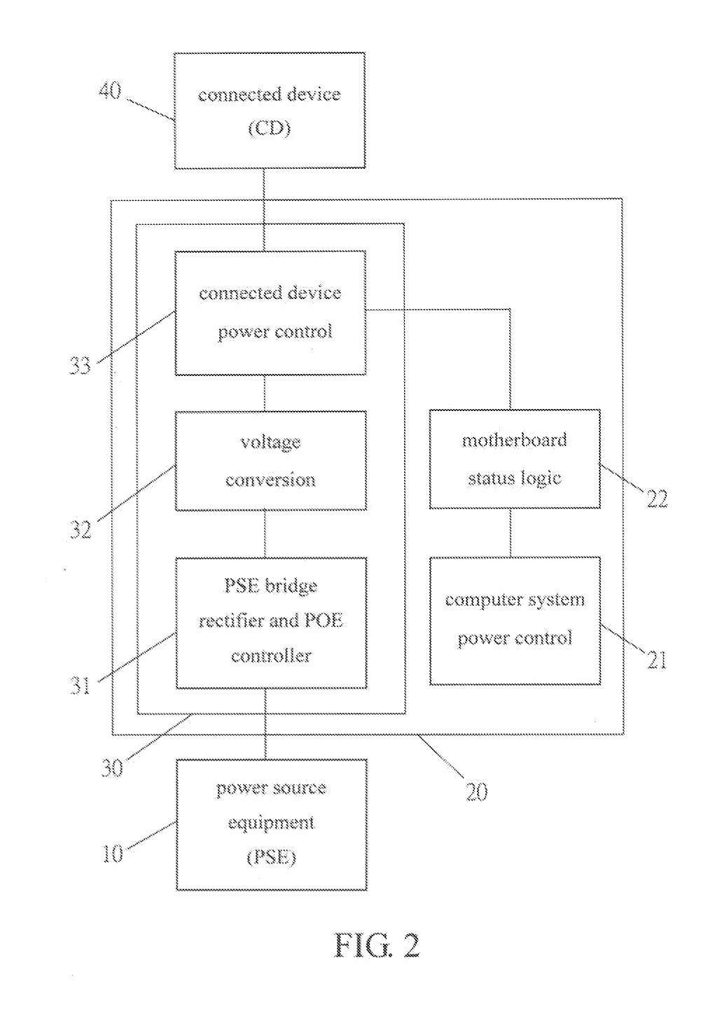

Referring to FIG. 2, the operating of the connected device power control 33 is based on the motherboard status logic 22 which determines the operational state of the computer system power control (ie: power button or software control) 21. Examining FIG. 2 the PSE 10 provides the power to the PD module 30 which is integral to the computer system 20. The PSE bridge rectifier and POE controller 31 and the converted into a suitable voltage type and voltage level for the CD 40 and the computer system 20. The voltage type and level maybe different for the CD 40 and computer system 20. When a user activates the computer system power control 21 by activating a power button or software controlled operation, the operational state of the motherboard status logic 22 indicates to the connected device power control 33 the operational state of the computer. If the motherboard status logic 22 indicates computer system 20 is in the ON state the connected device power control 33 is activated. The connected device power control 33 connects the power source from the PD module 30 to the CD 40 and the CD 40 is turned on to match the operational state of the computer system 20. The connected device power control 33 can operate the CD 40 independently once the connected device power control 33 has provided power to the CD 40. This allows any native power saving features of the CD 40 to still operate as designed. If the motherboard status logic 22 indicates computer system 20 is in the OFF state the connected device power control 33 is deactivated. The connected device power control 33 disconnects the power source from the PD module 30 to the CD 40 and the CD 40 is off to match the operational state of the computer system 20.

In conclusion, according to the above description of the embodiments of the present invention, a PD Module is provided with an independent and mutually connected common power supply system, which is able to synchronously turn on or turn off power supply to enable the system to function normally.

It is to be understood that the above description and drawings are only used for illustrating some embodiments of the present invention, not intended to limit the scope thereof. Any variation and deviation from the above description and drawings should be included in the scope of the present invention.

What is claimed is:

1. A controlling the operational state of a connected device powered by a mutually connected power source, wherein a PD (Powered Device) module is installed in a computer system, and a PSE (Power Source Equipment) supplies power to the PD module, the computer system using the DC outlet connecting the output switch, to link together the power supply, activate the motherboard voltage signal from the output switch activity, and the output switch is via a DC to DC convention connected.
